(19) United States
(12) Patent Application Publication
(10) Pub. No.: US 2005/0166227 A1
(43) Pub. Date: Jul. 28, 2005

(54) BACKGROUND ATSC PSIP RETRIEVAL PROCESS

(75) Inventor: Anirudh J. JOSHI, Palo Alto, CA (US)

Correspondence Address: DVA/PIONEER RESEARCH CENTER USA, INC.;INTELLECTUAL PROPERTY DEPARTMENT, 2355 MAIN STREET, SUITE 200, IRVINE, CA, 92614, US

(73) Assignee: PIONEER RESEARCH CENTER USA, INC., San Jose, CA (US)

(21) Appl. No.: 10/707,947

(22) Filed: Jan. 27, 2004

(51) Int. Cl. H04N 5/50; G06F 13/00; H04N 5/445

(52) U.S. Cl. 725/38; 725/39; 725/44; 348/731

(57) ABSTRACT

In a terrestrial broadcast system, a program manager filters program data via a first tuner while a second tuner receives one of audio or video information of a channel from a transport stream. The program data is then parsed for channel information. The channel information is stored in a database.

### FIELD OF THE INVENTION

The present invention relates generally to Program and System Information Protocol (PSIP), and more particularly, to the retrieval of PSIP program data in terrestrial broadcast systems.

### BACKGROUND OF THE INVENTION

As described in the ATSC (Advanced Television Systems Committee) standard, PSIP includes tables that have data describing the digital broadcasted channels and their programs. When retrieving PSIP program data in a terrestrial broadcast system, a device (i.e., set-top box) is tuned to a particular channel's frequency before the PSIP table packets are filtered. This can be a lengthy process since the PSIP table packets come in varying time intervals. The entire process to build a complete program data for the particular channel/frequency could take some time (i.e., 10 seconds) to complete. This means a user has to wait to see the program information for the particular channel and program. The process is repeated for each channel;

therefore, it takes several minutes to complete the process for a whole program guide.

The present invention provides a method to retrieve PSIP program data without having to wait for the device to scan table packets of a particular channel or all the channels.

This is achieved by using a second tuner of the device to do the scanning in the background while a first tuner is tuned to a selected channel for broadcasting its channel information.

The Program and System Information Protocol for terrestrial broadcast and cable specification as described in A/69 by Advanced Television Systems Committee is attached hereto (Appendix A) and incorporated herein by reference.

### BRIEF DESCRIPTION OF DRAWINGS

FIG. 1 is a block diagram illustrating a computer system in which one embodiment of the present invention can be practiced.

FIG. 2 is a block diagram illustrating a transmission system in which one embodiment of the present invention can be practiced.

FIG. 3A is a block diagram illustrating a video/audio system in which one embodiment of the present invention can be practiced.

FIG. 3B is a diagram illustrating more detail of FIG. 3A in which one embodiment of the present invention can be practiced.

FIG. 3C is a diagram illustrating a block diagram of the EPG Manager in which one embodiment of the present invention can be practiced.

FIG. 4 is a flow chart diagram illustrating how program data is scanned in the background of the video/audio system according to one embodiment of the invention.

FIG. 5 is a diagram illustrating an EPG in which one embodiment of the present invention can be practiced.

### DETAILED DESCRIPTION

In the following description, numerous specific details are set forth. However, it is understood that embodiments of the invention may be practiced without these specific details. In other instances, well-known circuits, structures, and techniques have not been shown in order not to obscure the understanding of this description.

System Level

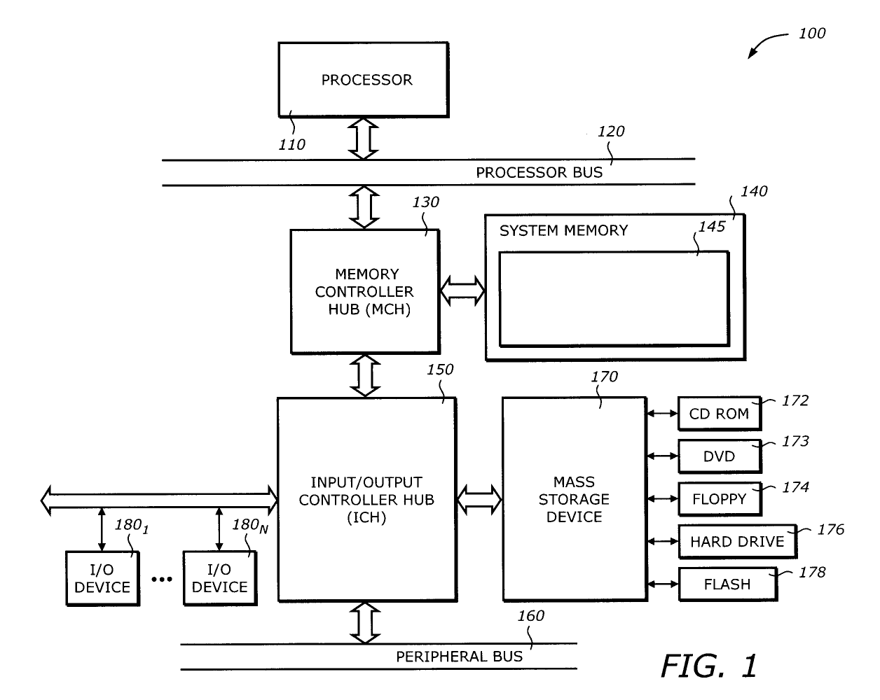

FIG. 1 is a diagram illustrating a processor system 100 in which one embodiment of the invention can be practiced. The processor system 100 includes a processor 110, a processor bus 120, a memory control hub (MCH) 130, a system memory 140, an input/output control hub (ICH) 150, a peripheral bus 160, a mass storage device 170, and input/output devices 180₁ to 180_{N}. Note that the processor system 100 may include more or less elements than these elements.

The processor 110 represents a central processing unit of any type of architecture, such as embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The processor bus 120 provides interface signals to allow the processor 110 to communicate with other processors or devices, e.g., the MCH 130. The processor bus 120 may support a uni-processor or multiprocessor configuration.

The processor bus 120 may be parallel, sequential, pipelined, asynchronous, synchronous, or any combination thereof.

The MCH 130 provides control and configuration of memory and input/output devices, the system memory 140, and the ICH 150. The MCH 130 may be integrated into a chipset that integrates multiple functionalities such as the isolated execution mode, host-to-peripheral bus interface, and memory control. The MCH 130 interfaces to the peripheral bus 160. For clarity, not all the peripheral buses are shown. It is contemplated that the system memory 140 may also include peripheral buses such as Peripheral Component Interconnect (PCI), accelerated graphics port (AGP), Industry Standard Architecture (ISA) bus, and Universal Serial Bus (USB), etc.

The system memory 140 stores system code (i.e., code to calculate a shared key) and data. The system memory 140 is typically implemented with dynamic random access memory (DRAM) or static random access memory (SRAM). The system memory 140 may include program code or code segments implementing one embodiment of the invention. The system memory includes a user interface management 145. Any one of the elements of the user interface management 145 may be implemented by hardware, software, firmware, microcode, or any combination thereof. The system memory 140 may also include other programs or data, which are not shown, such as an operating system. The user interface management 145 contains program code (i.e., EPG Manager) that, when executed by the processor 110, causes the processor 110 to perform operations as described below.

The ICH 150 has a number of functionalities that are designed to support I/O functions. The ICH 150 may also be integrated into a chipset together or separate from the MCH 130 to perform I/O functions. The ICH 150 may include a number of interface and I/O functions such as PCI bus interface to interface to the peripheral bus 160, processor interface, interrupt controller, direct memory access (DMA) controller, power management logic, timer, system management bus (SMBus), Universal Serial Bus (USB) interface, mass storage interface, low pin count (LPC) interface, etc.

The mass storage device 170 stores archive information such as code, programs, files, data, applications, and operating systems. The mass storage device 170 may include compact disk (CD) ROM 172, a digital video/versatile disk (DVD) 173, floppy drive 174, hard drive 176, flash memory 178, and any other magnetic or optical storage devices. The mass storage device 170 provides a mechanism to read machine-accessible media. The machine-accessible media may contain computer readable program code to perform tasks as described in the following.

The I/O devices 180₁ to 180_{N} may include any I/O devices to perform I/O functions. Examples of I/O devices 180₁ to 180_{N} include controllers for input devices (e.g., keyboard, mouse, trackball, pointing device), media cards (e.g., audio, video, graphics), network cards, and any other peripheral controllers. Elements of one embodiment of the invention may be implemented by hardware, firmware, software or any combination thereof. The term hardware generally refers to an element having a physical structure such as electronic, electromagnetic, optical, electro-optical, mechanical, electro-mechanical parts, etc. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc. that is implemented or embodied in a hardware structure (e.g., flash memory, ROM, EROM). Examples of firmware may include microcode, writable control store, and microprogrammed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine-accessible medium or transmitted by a computer data signal embodied in a carrier wave, or a signal modulated by a carrier, over a transmission medium. The processor-readable or accessible medium or machine-readable or accessible medium may include any medium that can store, transmit, or transfer information. Examples of the processor-readable or machine-accessible medium include an electronic circuit, a semiconductor memory device, a read-only memory (ROM), a flash memory, an erasable ROM (EROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine-accessible medium may be embodied in an article of manufacture. The machine-accessible medium may include data that, when accessed by a machine, causes the machine to perform the operations described in the following. The machine-accessible medium may also include program code embedded therein. The program code may include machine-readable code to perform the operations described in the following. The term data here refers to any type of information that is encoded for machine-readable purposes. Therefore, it may include program, code, data, file, etc.

All or part of an embodiment of the invention may be implemented by hardware, software, or firmware, or any combination thereof. The hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, an argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

Program and System Information Protocol (PSIP)

Program and System Information is data that is transmitted along with a station's DTV signal that provides DTV receivers information regarding the station and what is being broadcasted. PSIP provides information for DTV receivers to identify a DTV station and to determine how a receiver can be tuned to it. PSIP informs the receiver whether multiple program channels are being broadcasted and, if so, how to find them. In order for the receivers to correctly identify and tune to the station, broadcasters should properly encode broadcast and program data in their DTV stations signals.

PSIP is collection of tables designed to operate within every Transport Stream (TS) for terrestrial broadcast of digital television. PSIP describes the information at the system and even at levels for all virtual channels carried in a particular transport stream. Additionally, information for analog channels as well as digital channels from other Transport Systems may be incorporated.

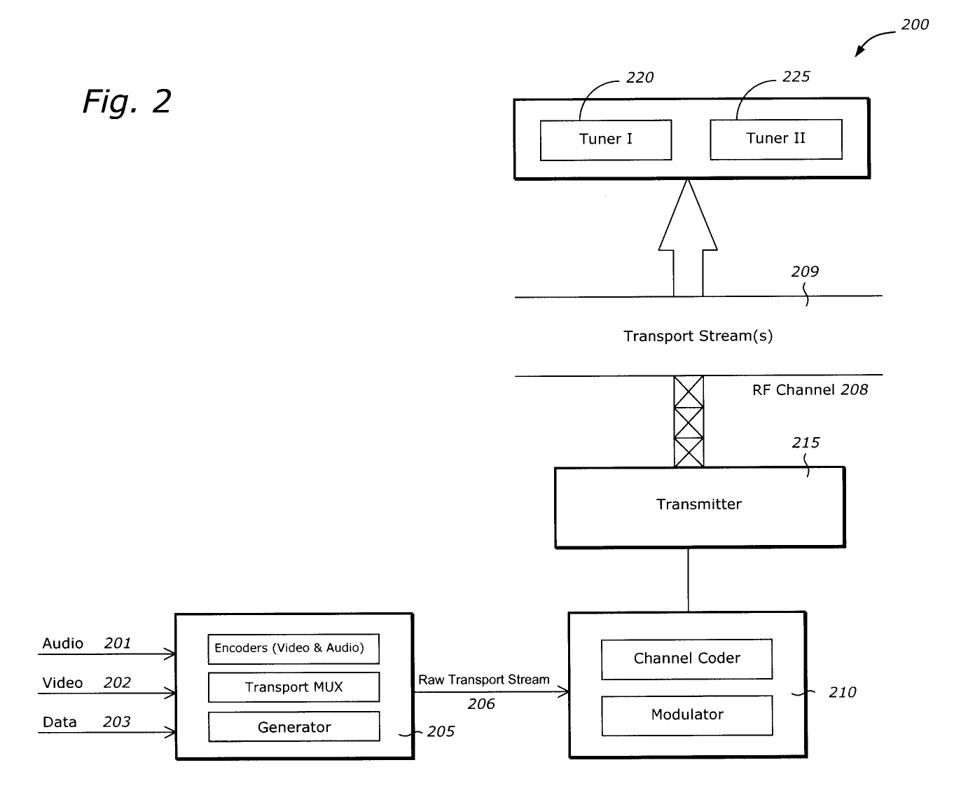

There are two main categories of information in PSIP Standard: system information and program data. System information allows navigation and access of the channels within the DTV transport stream, and the program data provides necessary information for efficient browsing and event selection. Some tables of the PSIP announce future events and some are used to locate the digital streams that make up an event. The PSIP data are carried via a collection of hierarchically arranged tables. FIG. 2 illustrates a block diagram of a PSIP generator in perspective relative to the ATSC transmission system.

As stated earlier, the PSIP is a collection of tables such as a system time table (STT), master guide table (MGT), virtual channel table (VCT), rating region table (RRT), event information table (EIT), extended text table (ETT), etc. These tables are designed to operate within every Transport Stream (TS) for terrestrial broadcast of digital television. Each table describes elements of typical digital television services. Although information for analog channels as well as digital channels from other TS may be incorporated, it is noted that not all of these tables are required for terrestrial and cable applications. Since the present application applies to terrestrial application, only information related to this application is discussed.

The STT is a small data structure that fits one transport stream packet and serves as a reference for time-of-day functions. The STT is sent in packets every second with the based PID. Receivers can use this table to manage various operations and scheduled events, as well as display time-of-day.

The MGT contains data pointers to the identification number of the packets that contain all other tables (with the exception of the STT). The MGT controls the versions of all broadcasting program tables. The MGT provides indexing information for the other tables that comprise the PSIP standard. The MGT lists key information about other tables including version numbers, table sizes, and packet identifiers (PIDs). It defines table sizes necessary for memory allocation during decoding and version numbers to identify those tables that need to be updated, and generates the packet identifiers that label the tables. The MGT allows simpler decoder designs for receivers because any change in PSIP status is flagged in this table. Only the base PID needs to be monitored by a receiver to detect changes in PSIP status.

The VCT, also referred to as the terrestrial VCT (TVCT), provides attributes of all virtual channels in the transport stream. The VCT contains a list of channels in the transport steam. The VCT stores the information for all channels. These channels and their attributes are or will be online. Among the attributes given are the channel name and channel number. This table contains a set of data that enables a receiver to tune and locate the service being broadcast. In other words, it contains information on each service that a broadcaster creates or has announced that will be created within the DTV channel assignment. Even though it may also include the broadcaster's analog, the present invention applies only to digital channels (e.g., terrestrial broadcasting). For terrestrial broadcasting, the terrestrial VCT is used (TVCT). The information contained in the VCT includes the channel numbers (major and minor) and transport stream identification (TSID), pointers to the component streams that make up a program, and descriptive information.

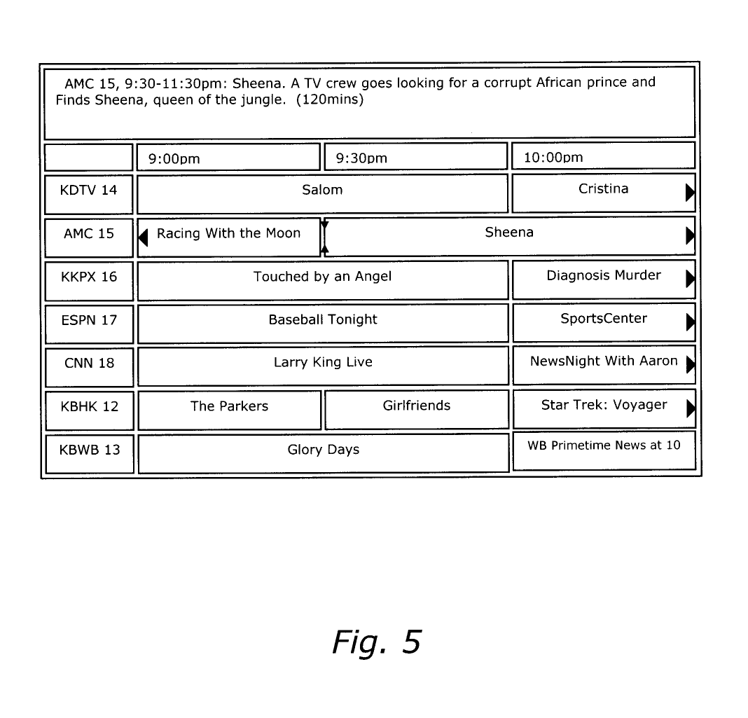

The EIT provides program titles and technical data about the planned events on the virtual channels and events. The EIT provides the information on the current broadcasting programs and future broadcasting programs. Each EIT covers a period of time (i.e., three hours). The starting time for each EIT may be constrained to be one of the CUT (Coordinated Universal Time), the current local time, 00:00 (midnight), 3:00, 6:00, 9:00, 12:00 (noon), 15:00, 18:00, and 21:00. EIT-0 represents the current three hours of programming. For terrestrial PSIP, the first four EIT's (EIT-0, EIT-1, EIT-2, and EIT-3), representing 9 to 12 hours of programming, are required. The maximum number of EIT's is 128, permitting up to 16 days' worth of program information to be delivered to receivers. FIG. 5 shows what a typical electronic program guide (EPG) might look like.

The RRT provides rating information for each geographic region and/or country. The RRT is where a rating table of each program is listed. The RRT has been designed to transmit the rating system in use for each country using the ratings. The content advisory descriptor, which may appear in the EIT and PMT, indicates, for a given event, the ratings for any or all of the rating dimensions defined in the RRT.

The ETT provides the detailed information on the current broadcasting programs and future broadcasting programs. It provides detailed descriptions of virtual channels and events. The PID of the ETT is defined in the MGT. Although ETT is optional for terrestrial applications, it is used when additional information about the entire event is desired. However, receivers may have limited support for descriptive text so there may be a trade-off between covering more events and more data about each event. Furthermore, the rate the information is sent can be adjusted by setting the time interval between ETT's to make more efficient use of bandwidth.

The three main tables (VCT, EIT, STT) contain information to facilitate suitably equipped receivers to find the components needed to present a program (event). Although receivers are expected to use stored information to speed channel acquisition, sometimes parameters must change and the VCT is the table that must be accurate each instant as it provides the actual connection path. If nothing has changed since an EIT was sent for an event, then the anticipatory use of data is expected to proceed, and when there is a change, the new parts would be used. There are certain must have items and must do rules of operations. If the PSIP elements are missing or wrong, there may be consequences, which will vary depending on the type of receiver. However, the key elements that must be set and/or checked will not be discussed since it is beyond the scope of the present invention. It is contemplated that the information contained herein applies, but is not limited to, broadcasters, network operators, infrastructure manufacturers, and receiver manufacturers.

The plurality of streams of digital source data is retrieved via tuners 220 and 225. Each stream represents a video, an audio, or an ancillary data services component, such as PSIP data of a television program. As stated above, the PSIP data from the transport stream may include control data and data associated with program audio and video services such as system information for a program guide. The data is retrieved from a filter (i.e., PID packet identifier filter), which scans the incoming stream for particular types of data (i.e., PSIP data). The PID filter may be implemented by hardware, firmware or software. The EPG Manager receives the PSIP data then parses the data for channel information. The channel information is embedded in the above-described tables of the PSIP transport stream. The data is then stored in a database (i.e., Program Guide Database). The database is used by a monitor application (i.e., any EPG which users see onscreen).

FIG. 2 illustrates a block diagram of a transmission system in which the present invention can be practiced. The system 200 includes a subsystem 205, a channel coder/modulator 210, a transmitter 215, and tuners 220 and 225. The subsystem 205 includes application encoders to encode audio signal 201 and video signal 202, a transport multiplexer to multiplex the bit streams from the encoders and other signals (i.e., data) to generate a raw transport stream 206. The transport streams are processed in application encoders, which perform data encoding and formatting before the streams are transmitted to the multiplexer where each stream is divided into packets. The channel coder/modulator 210 codes and/or modulates the raw transport streams 206 to generate a transport stream 209 to be transmitted to the tuners by the transmitter 215 via an RF (radio frequency) channel 208. In terrestrial broadcast television, the digital data in the transport stream is modulated and is received via tuners 220 and 225. The transport stream 209 carries video, audio, and program data.

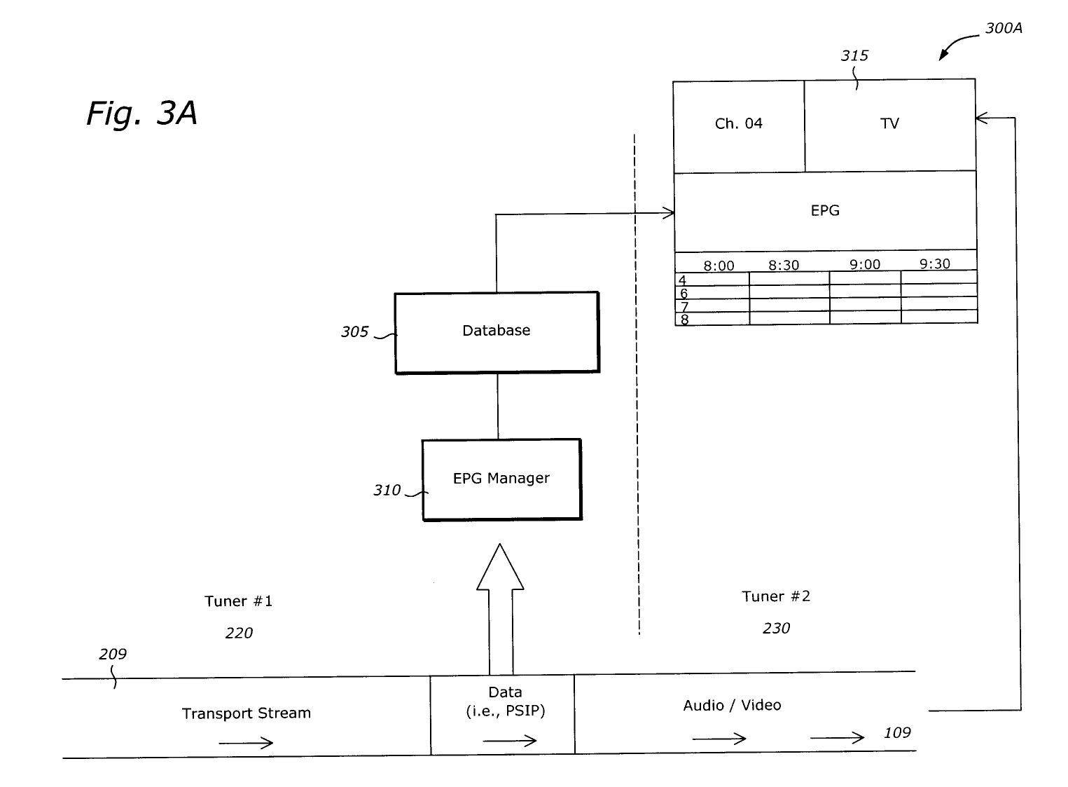

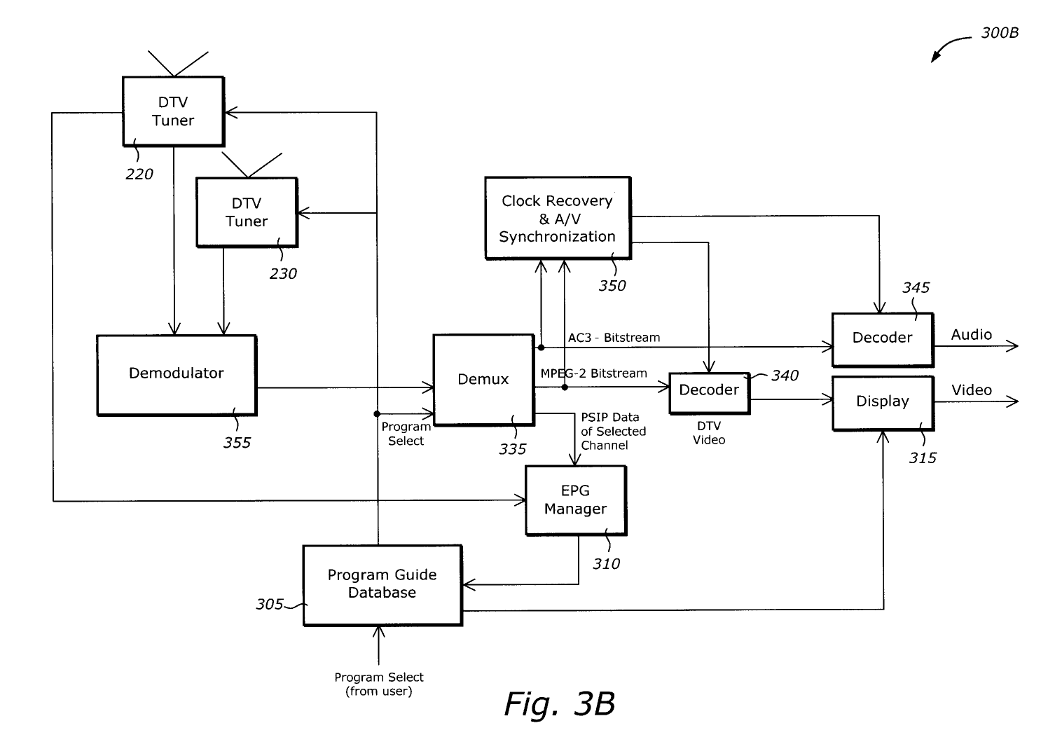

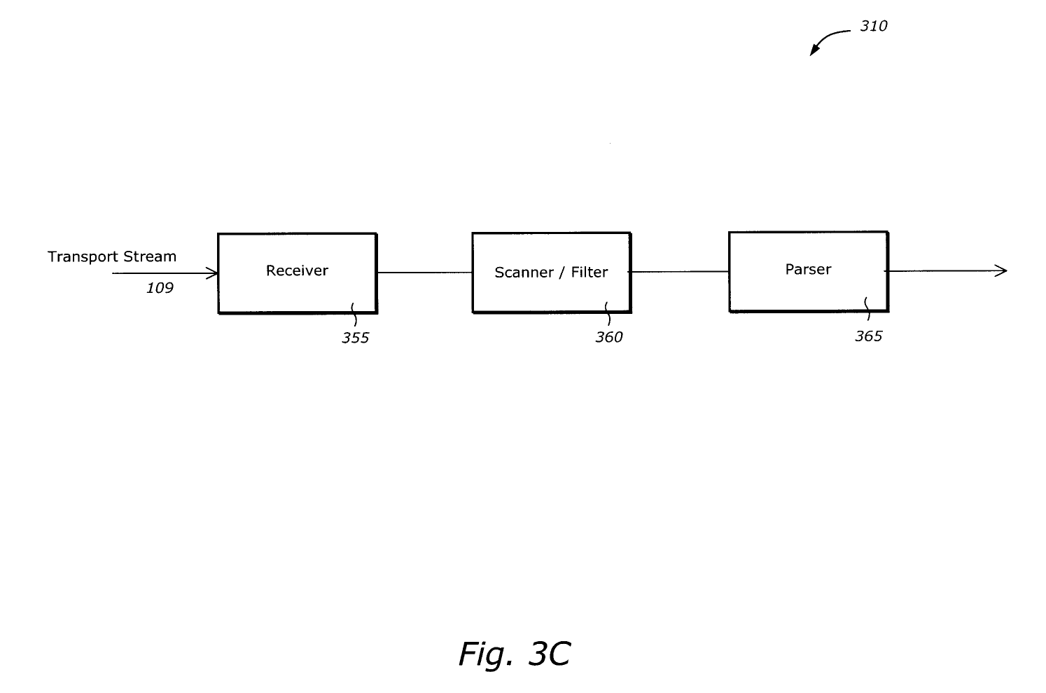

FIG. 3A illustrates a block diagram of a video/audio system in which one of the embodiments of the present invention can be practiced. The system 300A includes the tuner 220, the tuner 230, a Manager Module 310 (i.e., Electronic Program Guide (EPG) Manager), a channel database 305 (i.e., Program Guide database), and a display 315. The tuner 220 receives the transport stream 209 from the transmitter 215. The transport stream 209 includes video, audio, and program information of all channels. The EPG 310 retrieves the transport stream 209 from tuner 220 and filters the transport stream 209 for the PSIP table packets. The EPG 310 then parses the table packets data and then stores the information in the database 305 (i.e., program guide database). The program guide data is displayed on the display 315. Tuner 230 receives transport stream 109 when it is tuned to a selected channel. The video data of the selected channel is displayed on the displayed 315. The EPG may also be displayed on the display 315. The DTV tuner 230 is tuned to a selected program in response to commands from a user. The tuner 220 continues to receive transport streams of different channels, parses the transport streams for PSIP data, and stores the data into the program guide database 305.

FIG. 3B illustrates more details of a block diagram of a video and/or audio system in which one embodiment of the present invention can be practiced. The system 300B includes a demodulator 355, the tuner 220, the tuner 230, the EPG manager module 310, the program guide database 305, a demultiplexer 335, a video decoder 340 (i.e., MPEG2 ATV), an audio decoder 345 (i.e., AC3 with DAC's), a clock recovery and synchronization 350, and the display-processing unit 315. The display-processing unit 315 may include a television receiver that receives the multiprogram stream for a single tuned channel. It is contemplated that in terrestrial broadcast television, the transmission of the digital data in the transport stream is via a radio frequency.

The demodulator 355 coupled to the tuners 220 and 230, and the demultiplexer 335. The demodulator 355 demodulates the digital signal (i.e., the transport stream 109) carried in the physical channel selected by the tuner 230. The demultiplexer 335 receives the demodulated transport stream, extracts the video, audio, and data programs from the transport stream, depacketizes and demultiplexes the transport stream into video, audio, and ancillary data bit streams (i.e., AC bitstream, MPEG bitstream and PSIP data). It is noted that although the disclosed system is described in the context of a system for receiving terrestrial broadcast video signals incorporating ancillary program specific and timing information in MPEG compatible format, it is exemplary only. The MPEG data format is widely adopted and detailed in the MPEG-2 (Moving Pictures Expert Group) image standard. The program specific and timing information may be of a variety of types. The demultiplexer 335 separates the transport bit stream into streams of transport packets, which include data streams for video, audio and PSIP data. The demultiplexer 335 directs the data in each of the transport packet data streams to a decoder for that stream. These bitstreams may be stored in a buffer (not shown). The decoders 340 and 345 decode and reassemble the video and audio bitstreams respectively into data streams. The video decoder 340 decodes a video bit stream, which corresponds to the ATSC Digital Television Standard. The audio decoder 345 decodes an audio bit stream, which provides audio signals at output ports (i.e., speakers). The decoders cause the flow of data to be regulated so that data can be presented in synchronization with an instant of audio or visual information of the program. The video information is broadcasted via the display processing unit 315 and the audio stream is forwarded to a sound generation unit (i.e., speakers) (not shown). The decoding and the presentation of program data are coordinated by the clock recovery and synchronization 350. The clock recovery/synchronization 350 synchronizes the video and audio bit-streams. The clock recovery/synchronization 350 is used to generate timing signals to synchronize the operations between the video and audio decoders 340 and 345. The desired program is processed not only for display but also for recording or playback.

The EPG manager 310 retrieves data (i.e., PSIP data) from the transport streams of different channels, parses the data for channel information before storing the information into the program guide database 305. The database 305 may be a memory area, which is separate from the memory, used to decode the audio and video programs. The EPG manager 310 continues to retrieve data from the transport stream and parses the data for all channel information and stores the information into the database 305. While tuner 220 is used entirely to scan the entire channel for program data in the background, tuner 230 is used to tune a particular channel to broadcast that particular channel. When a channel/program is selected (i.e., by a user), tuner 230 tunes to that particular channel and retrieves the broadcast data from the transport stream via demodulator 355.

FIG. 3C illustrates a block diagram of the EPG Manager 310 in which one embodiment of the present invention can be practiced. The EPG Manager 310 includes a receiver 355, a scanner or filter 360 and a parser 365. The receiver 355 receives the transport stream 109 or transport stream from the demodulator 355 and transmits the transport stream to scanner/filter 360. The scanner/filter 360 scans or filters for program data packets for each channel. The parser 365 then parses for channel information and stores the information into the database 305. The parser 365 parses the event information from tables described above. It extracts the event information from a program specific information signal sequence in the transport stream packet of the PSIP data and displays the parsed information on a display device (not shown) (i.e., TV screen).

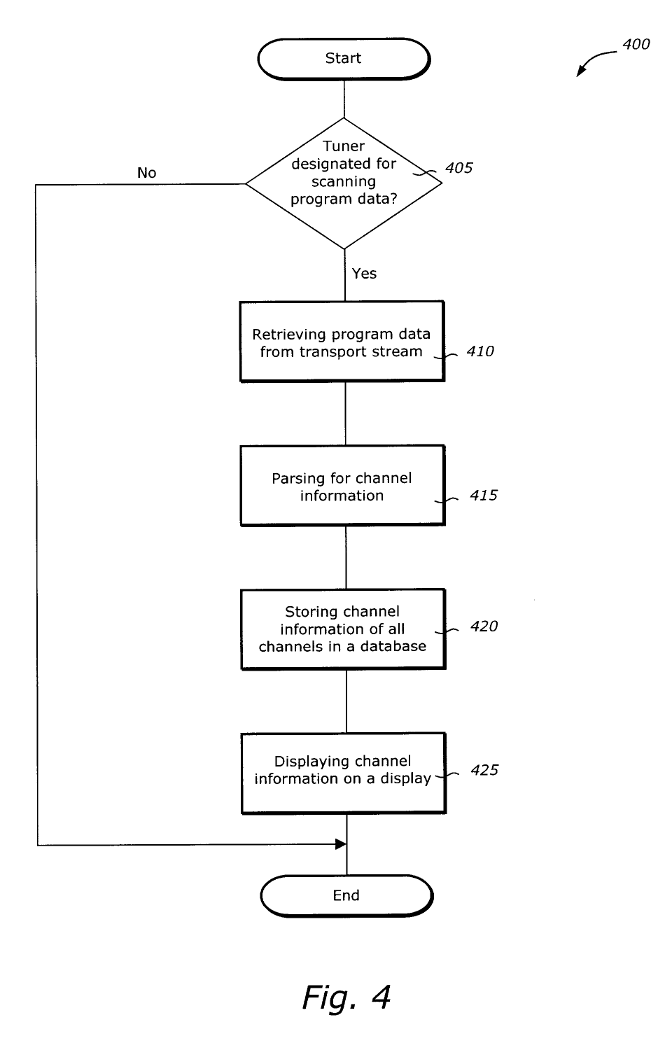

FIG. 4 illustrates a flow chart of the retrieving program data process in which one embodiment of the invention can be practiced. At start, the process 400 determines whether a tuner is designated for scanning program data of all channels (Step 405). If not, the process 400 is terminated. Otherwise, the process 400 continues at Step 410 by retrieving program (i.e., PSIP) data from a transport stream for each channel by a Manager (i.e., EGP Manager) module. The program data/information may be retrieved from a hardware filter (i.e., PID filter). Once the raw data is retrieved, the data is parsed for channel information (Step 415). The process 400 then continues with Step 420 by storing the channel information of all channels into database. The channel information includes information regarding data in an Electronic Program Guide (EPG). In Step 425 of process 400, the program data is displayed on a display device. The displayed information may be displayed on the EPG. The process 400 is terminated.

While certain embodiments are illustrated in the drawings and have been described herein, it will be apparent to those skilled in the art that many modifications can be made to the embodiments without departing from the inventive concepts described.

1. A method for retrieving program data in a terrestrial broadcast system comprising:
filtering program data via a first tuner while a second tuner receives audio or video information of a channel from a transport stream;
parsing the program data for channel information; and
storing the channel information in a database.

2. The method according to claim 1 wherein the program data is provided by a protocol.

3. The method according to claim 2 wherein the protocol is a program and system information protocol (PSIP).

4. The method according to claim 3 wherein the PSIP includes one of system time table, master guide table, virtual channel table, rating region table, event information table, extended table, directed channel change table and directed channel change selection code table.

5. The method according to claim 3 wherein at least one table includes program data information.

6. The method of claim 1 further comprising coding and modulating the transport stream.

7. The method of claim 6 further comprising transmitting the transport stream via a channel.

8. The method according to claim 3 wherein the program data is provided for browsing or event selection.

9. The method according to claim 1 further comprising identifying a channel of the digital television station from the transport stream.

10. The method according to claim 3 further comprising tuning to the channel by a receiver.

11. A machine-accessible medium including data that, when accessed by a machine, causes the machine to perform operations comprising:
filtering program data via a first tuner while a second tuner receives audio or video information of a channel from a transport stream;
parsing the program data for channel information; and
storing the channel information in a database.

12. The machine-accessible medium according to claim 11 wherein the program data is provided by a protocol.

13. The machine-accessible medium according to claim 12 wherein the protocol is a program and system informamation protocol (PSIP).

14. The machine-accessible medium according to claim 13 wherein the PSIP includes one of system time table, master guide table, virtual channel table, rating region table, event information table, extended table; directed channel change table and directed channel change selection code table.

15. The machine-accessible medium according to claim 13 wherein at least one table includes program data information.

16. The machine-accessible medium of claim 11 further comprising coding and modulating the transport stream.

17. The machine-accessible medium of claim 16 further comprising transmitting the transport stream via a channel.

18. The machine-accessible medium according to claim 13 wherein the program data is provided for browsing or event selection.

19. The machine-accessible medium according to claim 11 further comprising identifying a channel of the digital television station from the transport stream.

20. The machine-accessible medium according to claim 23 further comprising tuning to the channel by a receiver.

21. A system comprising:
a processor; and
a memory coupled to the processor, the memory containing program code that, when executed by the processor, causes the processor to:
filter program data via a first tuner while a second tuner receives audio or video information of a channel from a transport stream;
parse the program data for channel information; and
store the channel information in a database.

22. The system according to claim 21 wherein the program data is provided by a protocol.

23. The system according to claim 22 wherein the protocol is a program and system information protocol (PSIP).

24. The system according to claim 23 wherein the PSIP includes one of system time table, master guide table, virtual channel table, rating region table, event information table, extended table, directed channel change table and directed channel change selection code table.

25. The system according to claim 23 wherein at least one table includes program data information.

26. The system according to claim 21 further comprising coding and modulating the transport stream.

27. The system according to claim 26 further comprising transmitting the transport stream via a channel.

28. The system according to claim 23 wherein the program data is provided for browsing or event selection.

29. The system article according to claim 21 further comprising identifying a channel of the digital television station from the transport stream.

30. The system according to claim 23 further comprising tuning to the channel by a receiver.
